(19) United States
(12) Patent Application Publication
(10) Pub. No.: US 2006/0004694 A1
(43) Pub. Date: Jan. 5, 2006

(54) Engineering analysis database and analysis interface thereof

(76) Inventor: Yih-Ping Huang, Taichung City (TW)

Correspondence Address: BIRCH STEWART KOLASCH & BIRCH, PO BOX 747, FALLS CHURCH, VA, 22040-0747, US

(21) Appl. No.: 10/860,025

(22) Filed: Jun. 4, 2004

(51) Int. Cl. G06F 17/30

(52) U.S. Cl. 707/2

(57) ABSTRACT

The invention discloses an engineering analysis database and analysis interface thereof, which utilizes a traditional analysis program to analyze all the variables residing in a certain engineering problem, exam the variables from all possible aspects, and then collect the obtained results in a database. To analyze a specific problem, it can simply apply the database and use interpolation method according to the variables, and then an approximate solution of the problem can be obtained. As to the variables involved in the engineering problems, one or two specific items can be treated as unknown values for solution. Also, as for the analysis interface, because the method of database interpolation for solution is unified, any engineering analysis problem can apply the unified interface program for interpolation as long as the problem meets the condition for being a continuous behavior problem.

### FIELD OF THE INVENTION

The invention relates to an engineering analysis database and analysis interface thereof and, more particularly, to engineering analysis that can be applied to problems such as having multiple parameters and continuous behavior involved in the engineering industry, for instance, stress analysis involved in civil engineering, mechanical engineering, architectural engineering, and hydraulic engineering.

### BACKGROUND OF THE INVENTION

So far, the method of traditional stress analysis has been limited to adopting specific analysis program that applies single license or multiple licenses for local area connection. Besides, such analysis program has to treat each parameter as required input and then obtain safety coefficient through parameters. However, there are drawbacks with respect to this method, which are listed as below:

(1) this method has to depend on certain analysis program; in other words, certain program has to be purchased, learned, maintained, and updated;

(2) when doing analysis, many calculations have to be carried out for obtaining a solution because the existed safety coefficient factor must be applied to obtain one or more parameters for the solution of problem;

(3) the applied analysis program does not promise having commonality; and

(4) sharing experiences with a new user is not an easy job to do.

In view of the above-mentioned problems, the present invention has come up with a solution that can improve drawbacks of the prior arts.

### SUMMARY OF THE INVENTION

The rule for applying the invention is that as long as there is one unit (or more than one unit) responsible for constructing a database, the global users in the world can apply the database through Internet; therefore, the more the related engineering databases can be constructed, the more the services can be provided. Through the method of building unified format and applied interface thereof, the invention has following advantages in comparison with the prior arts:

(1) the expenditure and dependence that a person has to pay for a specific analysis program can be exempted;

(2) by applying the interpolation method, an accurate and fast solution can be obtained for solving common engineering problems;

(3) constructing, maintaining, and updating a database can be done by only a few units of dedicated team; and

(4) a unified database format is adopted, which in turn can expand providers and participators for the database.

To achieve the aforementioned objects, the database will be applied when analyzing a specific problem, and to obtain an approximate solution, the variables will be interpolated into the database. As to variables involved in analyzing engineering problems, any one (or two) specific item can be treated as unknown value to obtain a solution.

Because the invention focuses on the problem of continuous behavior, the interpolation method can be operated under a unified interface. Similarly, through the specifications that the invention employs to construct the database, the user can execute interpolation for solution at a remote terminal through Internet interface provided by the invention no matter where the database is constructed. Also, in order to provide the same inquiry interface (i.e., the same web page) to different databases for use, the invention designs a method that places a database and its profile at the same location so as to facilitate the inquiry interface arranging and configuring data in the database.

The objects and technical contents of the invention will be better understood through the descriptions of the following embodiment with reference to the drawings.

### BRIEF DESCRIPTION OF THE DRAWINGS

FIG. 1 is a schematic diagram illustrating a numerical data table constructed according to the invention.

FIG. 2 is a schematic diagram illustrating a profile data table constructed according to the invention.

FIGS. 3A and 3B are flow charts illustrating the flow of inquiring according to the invention.

FIG. 4 is a schematic diagram illustrating the initialization screen of the invention.

FIG. 5 is a schematic diagram illustrating the screen of remote database of the invention.

FIG. 6 is a schematic diagram illustrating the inquiry interface of the invention.

FIG. 7 is a schematic diagram illustrating the result screen of output data.

### DETAILED DESCRIPTION OF THE PREFERRED EMBODIMENTS

The invention employs a method that puts the profile data and numerical data in the same database so that the profile data can be changed subject to the changes made by the numerical data and can be converted together with the numerical data. With this method, application of database can be more flexible and therefore can reduce disturbances to users. To achieve the method, the database of the invention must include a numerical data table and a profile data table, which will be explained in detail as below:

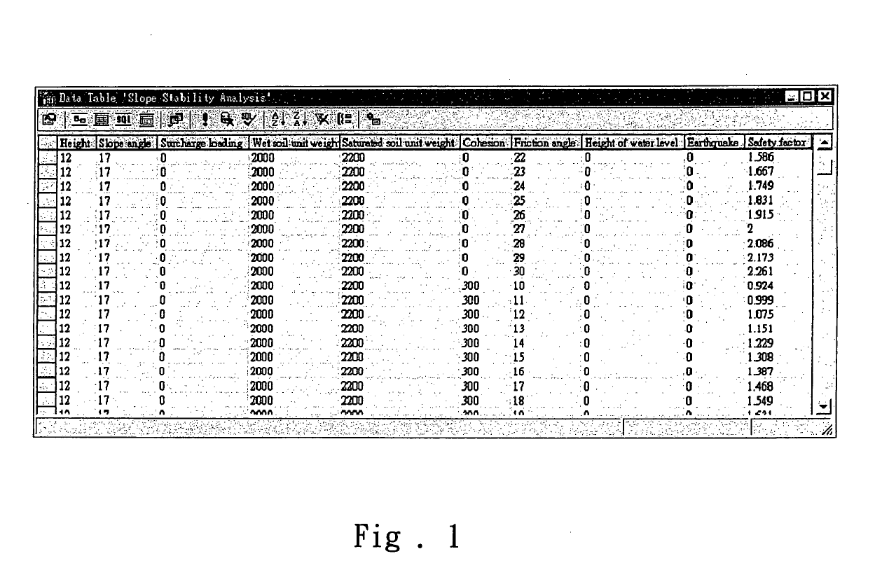

1. Numerical Data Table: firstly, all the parameters will be sorted and rearranged, and then the result will be calculated by means of common analysis software. Next, a data table will be made according to the parameters and result values. FIG. 1 illustrates the contents of typical numerical data table, which uses numerical data table of Landfill Datable as an example. After sorting, rearranging, and calculation, normally tens of thousands of data can be generated. As shown in FIG. 1, the column of Friction angle is the only column that shows figures in descending order, whereas figures in the other columns remain the same. There is no restriction set to limit the name of data table and the name of column and quantity of column contained in the data table thereof; in other words; each name used, such as Height, Slope angle, and Surcharge loading as shown in FIG. 1, can be defined on free will when the database is provided.

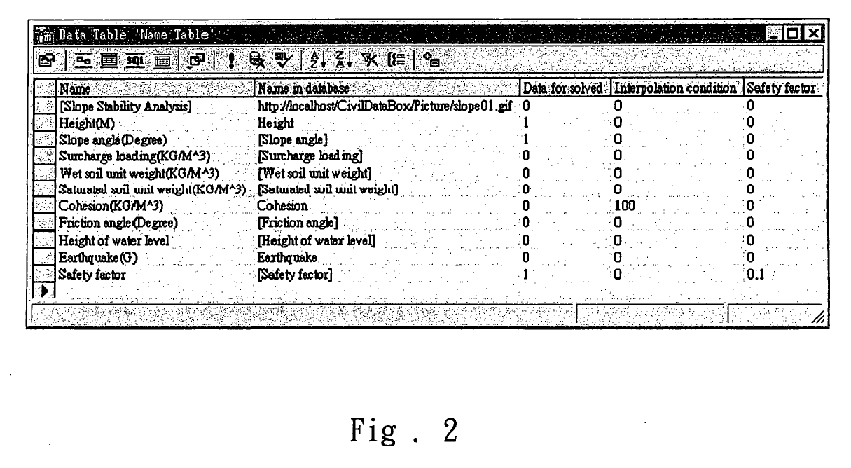

2. Profile Data Table: The purpose of profile data table is to provide relative parameters that are required in the existed interface program with a connection to the external interface program and aforementioned numerical data table. The contents of profile data table include the name of numerical data table, the name of every column contained in the numerical data table, and the relative configuration. Therefore, it is acceptable that data from a few to tens of data can be included in the profile data table. Referring to FIG. 2, the contents of profile data table may include different items such as Height, Slope angle, Surcharge loading and so forth, which are item names shown in Landfill Database.

When the analysis program is reading the above-mentioned profile data table, the analysis program will define the table in terms of location of data grid. Therefore, it is unnecessary to specify the name of each column when constructing the profile data table; instead, the following defining rules should be complied with when allocating data:

1. The first column (text data): the first data recorded in the first column is the name of numerical data table in the database, whereas the rest data in the same column are descriptions of all input headings on the displayed interface.

2. The second column (text data): the first data placed in this column can be website address of a schematic diagram, whereas each of the rest data in the same column is respectively corresponding to the name of each column shown in the aforementioned numerical data table.

3. The third column (logic data): to judge whether the data is waiting to be solved.

4. The fourth column (numerical data): to judge whether the data meets the interpolation condition and use the data as a reference for calculating class interval.

5. The fifth column (numerical data): to judge whether the data is the analysis result (such as safety coefficient) and use the data as a reference for calculating class interval.

The database that is constructed according to the rules of invention can be adaptable to all analysis interfaces for expanding their functions by simply revising the contents of profile data table.

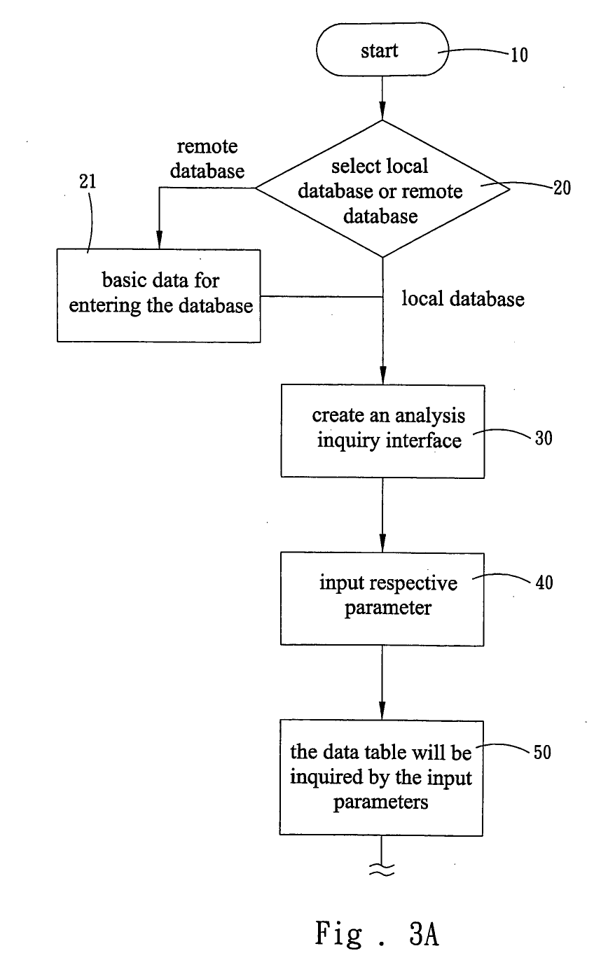

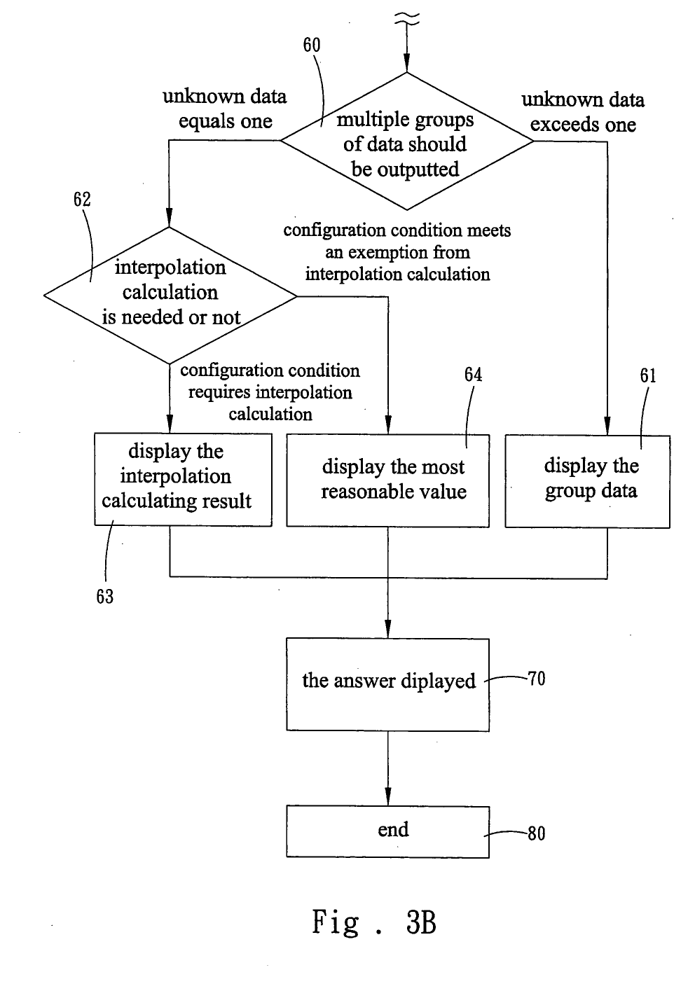

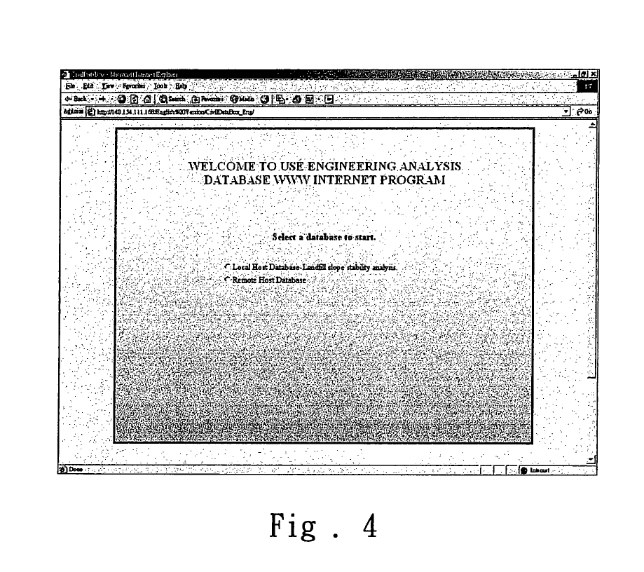

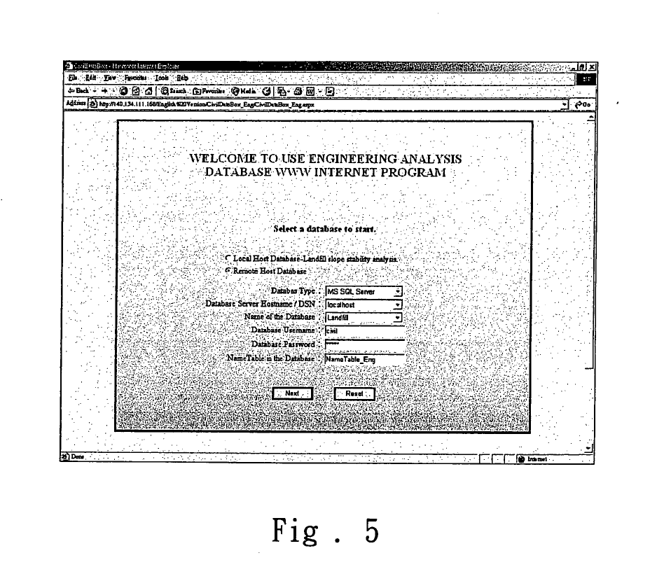

Also, the invention employs ASP.NET to write the web-page program for the analysis interface. Besides, the database format applies MS SQL Server; however, other database formats can be applicable, such as Oracle. When designing the analysis interface program of the invention, each input variable name and display string is allowed to be changeable subject to the profile data table in database. Also, FIGS. 3A and 3B illustrate the inquiry flowcharts of the invention, wherein the program starts 10, and then the user has to select local database or remote database 20. Next, FIG. 4 illustrates the initialization screen that shows an example of slope stability analysis for a sanitary landfill. If the remote database is used, the program will require basic data for entering the database 21, as shown in FIG. 5. The basic data includes database server hostname, name of the database, database username, database password, and name table in the database. Of course, the database rules shown in FIG. 5 are set according to the aforementioned database. The advantage of using remote database is that anybody is allowed to be a database provider so that each database provider can easily finish database construction, and database location can be moved anytime without affecting operation of the analysis interface program.

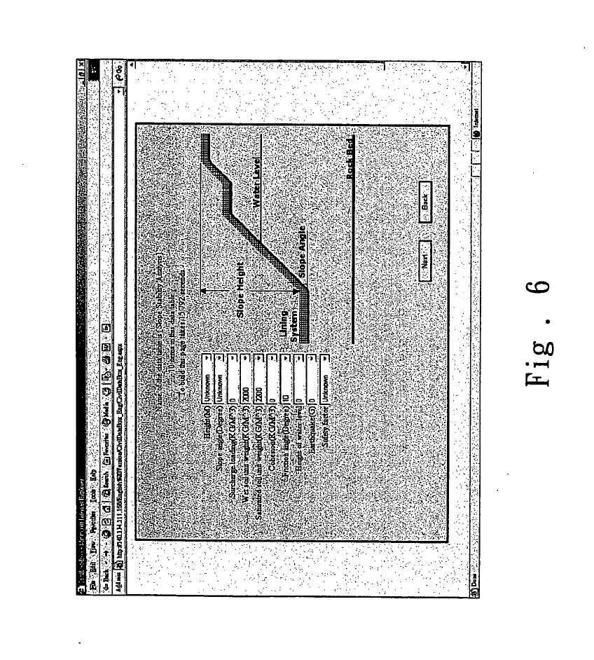

After finishing the foregoing basic data input, the analysis interface program of the invention will completely search the numerical data table and then group and sort each parameter into a selectable item for a pull-down menu to creat an analysis inquiry interface 30 (referring to FIG. 6). The operation needs only a few seconds to complete. After that, all the parameters in the finished inquiry interface will be inputted by a pull-down menu, and through the menu, the input value from users can be ensured to be within the range provided by the database. Also, the pull-down menu is a convenient input method for mobile Internet browsing tools, such as PDA and cell phones. Then, users can input respective parameter 40 through selections provided on the pull-down menu. After that, the data table will be inquired by the input parameters 50.

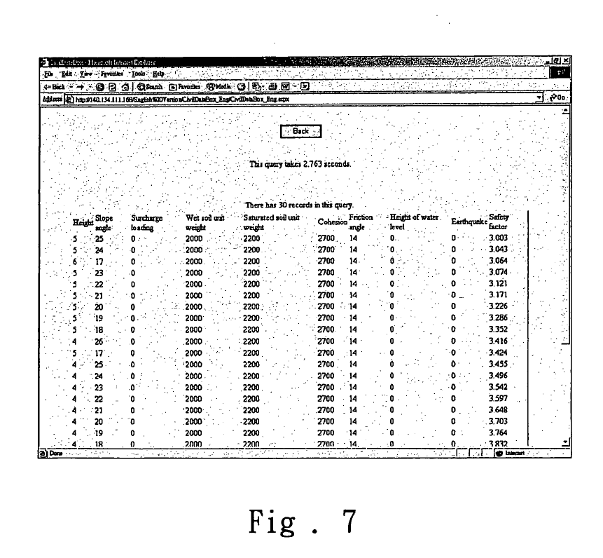

Next, a decision will be made whether multiple groups of data should be outputted 60 depending on whether the unknown data waiting to be resolved is more than one. If unknown data exceeds one (i.e., at least two), it will display the group data 61. On the other hand, if unknown data equals one, then a decision has to be made first, which is to decide whether interpolation calculation is needed or not 62. If configuration condition meets an exemption from interpolation calculation, it will display the most reasonable value 64. If, however, configuration condition requires interpolation calculation, then after calculation, an inquiry will be carried out one more time according to the obtained interpolation condition. By these two inquiry results, a solution can be obtained by applying linear interpolation, and then, it will display the interpolation calculating result 63. Thus, according to what is described above, the answer is displayed 70 according to the parameters configured by the user, as shown in FIG. 7. Finally, the display interface program comes to an end 80 after deciding whether the display screen should remain.

In conclusion, when analyzing a specific problem for obtaining an approximate solution, the approach is to apply the database first and then go for interpolation according to the variables. As to the variables involved in engineering problem analysis, one or two specific items can be treated as unknown value for solution. By doing so, the method disclosed in the invention is capable of having various solutions. To sum up, the specific features of the invention include: (1) calculation method employed by traditional engineering program that focuses on safety coefficient only can be exempted as well as can avoid repeated calculations for getting the solution; (2) a solution can be obtained by simply applying the interpolation method without too much calculation; (3) it is optional to select one or two specific items as unknown value for solution.

As for analysis interface program, the invention is able to unify the aforementioned method of database interpolation for solution; that is, no matter what kind of engineering problem it may be, it can apply the unified interface program for interpolation as long as it meets the premise of being a continuous behavior problem. The invention is to build specifications for a database, which allows a user to do interpolation for solution through Internet interface program from a remote terminal no matter where the database is constructed by the user.

What is claimed is:

1. An engineering analysis database, including a numerical data table and a profile data table therein, wherein the numerical data table is capable of focusing on any engineering analysis item, sorting and rearranging all parameters, and calculating result values through common analysis software, and then a data table is formed according to the parameters and the result values;
the profile data table is to provide relative parameters required by the interface program so as to connect to an external interface program and said numerical data table.

2. The engineering analysis database of claim 1, wherein there is no restriction set to limit a name of the numerical data table and names of columns and quantities of columns contained in the numerical data table thereof.

3. The engineering analysis database of claim 1, wherein contents of the profile data table include the name of numerical data table, the name of each column in the numerical data table, and a relative configuration.

4. The engineering analysis database of claim 1, wherein when allocating data to the profile data table, the following rules must be complied with:
the first column (text data): the first data recorded in the first column is the name of numerical data table in the database, whereas the rest data in the same column are descriptions of all input headings on the displayed interface;
the second column (text data): the first data placed in this column can be website address of a schematic diagram, whereas each of the rest data in the same column is respectively corresponding to the name of each column shown in the numerical data table;
the third column (logic data): to judge whether the data is waiting to be solved;
the fourth column (numerical data): to judge whether the data meets the interpolation condition and use the data as a reference for calculating class interval; and
the fifth column (numerical data): to judge whether the data is an analysis result and use the data as a reference for calculating class interval.

5. An analysis interface of engineering analysis database, wherein a analysis interface program will completely search the numerical data table once and then group and sort each parameter into a selectable item for a pull-down menu so as to construct an analysis inquiry interface.

6. The analysis interface of engineering analysis database of claim 5, wherein the parameters are input by means of a pull-down menu.
